(19) United States
(12) Patent Application Publication
(10) Pub. No.: US 2018/0044207 A1
(43) Pub. Date: Feb. 15, 2018

(54) CONTROLLING REGENERATION OF AN ELECTRODE IN UNIDIRECTIONAL PH ADJUSTMENT OF WATER

(71) Applicant: KONINKLIJKE PHILIPS N.V., ElNDHOVEN (NL)

(72) Inventors: QING LI, EINDHOVEN (NL); GUANGWEI WANG, EINDHOVEN (NL)

(21) Appl. No.: 15/555,629

(22) PCT Filed: Mar. 22, 2016
(86) PCT No.: PCT/EP2016/056183

§ 371 Date: Sep. 5, 2017

(30) Foreign Application Priority Data
Mar. 26, 2015 (CN) PCT/CN2015/075137
May 28, 2015 (EP) 15169533.5

(51) Int. Cl. C02F 1/461; C02F 1/66

(52) U.S. Cl. CPC C02F 1/4618; C02F 1/66; C02F 2201/46135; C02F 2201/46145

(57) ABSTRACT

Methods and apparatus for controlling regeneration of an electrode in unidirectional pH adjustment (“UpA”) of water. Some embodiments relate to obtaining one or more measured or otherwise known parameters related to a UpA cell (132), and controlling when a regeneration period is started, parameters for the regeneration period, and/or other inputs to the UpA cell based on the parameters. Some embodiments relate to taking the total desired and/or undesired ions production rate and/or energy efficiency of a UpA cell into account in determining discharging parameters for a regeneration period, when the regeneration period should be performed, and/or other inputs to the UpA cell.

### FIELD OF THE INVENTION

The present invention is directed generally to controlling regeneration of an electrode in unidirectional pH adjustment of water. More particularly, various inventive methods and apparatus disclosed herein relate to obtaining one or more values related to a unidirectional pH adjustment (“UpA”) cell, and controlling when a regeneration period of the UpA cell is started, parameters for the regeneration period, and/or other parameters related to inputs to the UpA cell based on the values.

### BACKGROUND OF THE INVENTION

WO 2014/102636 (Attorneys' docket 2013PF00021), incorporated herein by reference, relates to domestic water property adjustment, especially to a pH adjustor and a home appliance including the pH adjustor capable of unidirectional pH adjustment without producing waste water. The pH adjustor comprises an electrolysis cell including an anode and a cathode: the cathode comprising pseudocapacitance material, in operation of the pH adjustor, the pseudo-capacitance material gets electrons from the anode and adsorbs cations from an electrolyte aqueous solution (e.g. domestic water) by electrochemically reacting with said anions, OH− in the electrolyte aqueous solution are consumed by losing electrons, leaving H+ in the electrolyte aqueous solution; or the anode comprises pseudocapacitance material, and in operation of the pH adjustor, the pseudocapacitance material loses electrons and adsorbs anions from the electrolyte aqueous solution by electrochemically reacting with said anions, H+ in the electrolyte aqueous solution are consumed at the cathode by getting electrons, leaving OH− in the electrolyte aqueous solution.

Unidirectional pH adjustment (“UpA”) is a technique for unidirectionally adjusting pH of water during water electrolysis only in one direction. Thus, when UpA is utilized, only acidic water or only alkaline water is produced (which is produced will depend on the desired implementation)—and waste water is not produced or is produced at a reduced level as compared to other electrolysis techniques. When UpA is utilized for adjusting pH of water, only the pH of the water at the counter electrode is changed while that at the working electrode is stable. The working electrode in UpA may be, for example, an active carbon based (“AC”) working electrode that works as a super capacitor during electrochemical reaction. The counter electrode in UpA may be, for example, an inert metal such as titanium (Ti).

In UpA there are two periods: a “working period” and a “regeneration period.” During the working period the working electrode is in a charging state while the counter electrode is generating ions required for the desired pH change. For example, where UpA is applied to increase the pH of water, the counter electrode produces required H+ ions during the working period. During the regeneration period, the working electrode is in a discharging state while the counter electrode is generating ions that are undesired for the desired pH change. For example, where UpA is applied to increase the pH of water, the counter electrode produces undesired OH− ions during the regeneration period.

As described above, during the regeneration period the working electrode is discharging to enable the working electrode to again be charged during the working period. The regeneration period may be set to occur upon occurrence of a fixed condition, such as when the working electrode is fully charged and/or when the transient voltage drop on the working electrode is close to the decomposing voltage of water. However, this and/or other techniques may suffer from one or more drawbacks. For example, one or more of the techniques may not determine discharging parameters with which the regeneration period is to be performed such as discharging time, a magnitude of reverse voltage applied during the regeneration period, etc. Also, for example, one or more of the techniques may not consider certain measured or otherwise known parameters related to a unidirectional pH adjustment cell to determine a charging status of a working electrode at which regeneration should be performed. Also, for example, one or more of the techniques may not take into account effects on the production rate of desired and/or undesired ions and/or energy efficiency in determining discharging parameters for a regeneration period and/or when the regeneration period should be performed.

### SUMMARY OF THE INVENTION

Thus, there is a need in the art to provide alternative techniques for controlling regeneration of an electrode in unidirectional pH adjustment of water. The invention is defined by the independent claims. The dependent claims define advantageous embodiments.

The present disclosure is directed to inventive methods and apparatus for controlling regeneration of an electrode in unidirectional pH adjustment (“UpA”) of water. For example, various inventive methods and apparatus disclosed herein relate to obtaining one or more measured or otherwise known parameters related to a UpA cell, and controlling when a regeneration period is started, parameters for the regeneration period, and/or other inputs to the UpA cell based on the values. Some embodiments relate to determining discharging parameters for a regeneration period, such as discharging time, a magnitude of reverse voltage applied during the regeneration period, etc. Some embodiments relate to determining when a regeneration period should be performed based on one or more measured values related to a UpA cell such as voltage(s) applied by a power source to the UpA cell, current(s) applied by the power source, and/or a rate at which water is supplied to the UpA cell. Some embodiments relate to taking the total desired and/or undesired ions production rate and/or energy efficiency of a UpA cell into account in determining discharging parameters for a regeneration period and/or when the regeneration period should be performed.

In one aspect, a method of controlling regeneration of an electrode in unidirectional pH adjustment of water may include: obtaining a plurality of parameters related to a unidirectional pH adjustment cell, the unidirectional pH adjustment cell including a working electrode and a counter electrode; determining, based on optimizing a production rate of desired ions in the unidirectional pH adjustment cell in view of the parameters, a regeneration duration of a regeneration period of the unidirectional pH adjustment cell and a working duration of a working period of the unidirectional pH adjustment cell; and charging the unidirectional pH adjustment cell for the determined working duration; and discharging the unidirectional pH adjustment cell for the determined regeneration duration.

In some embodiments, obtaining the plurality of parameters includes receiving at least one value of the parameters from a sensor sensing the parameter. In various versions, the sensor is a flow meter and the value is a flow rate of water provided to the unidirectional pH adjustment cell. In various versions, the sensor is a voltmeter and the value is a voltage of a circuit that includes the working electrode, the counter electrode, and a power supply coupled to the working electrode and the counter electrode.

In various embodiments, determining, based on optimizing the production rate of desired ions in the unidirectional pH adjustment cell in view of the parameters, the regeneration duration and the working duration includes: determining the regeneration duration maximizes an average production rate of desired ions during charging of the unidirectional pH adjustment cell; and determining the regeneration duration minimizes a production rate of undesired ions during discharging of the unidirectional pH adjustment cell. In various versions, determining, based on optimizing the production rate of desired ions in the unidirectional pH adjustment cell in view of the parameters, the regeneration duration and the working duration includes: determining a working voltage drop of the working electrode at a start of the working period (V_{AC0}) and a regeneration voltage drop of the working electrode at a start of the regeneration period (V_{ACE}) that minimize a first objective function in view of the parameters and that maximize a second objective function in view of the parameters, the first objective function indicative of an average production rate of desired ions during charging of the unidirectional pH adjustment cell, and the second objective function indicative of an average production rate of undesired ions during discharging of the unidirectional pH adjustment cell; and determining the regeneration duration and the working duration based on the determined V_{AC0} and V_{ACE}. In various embodiments, determining the regeneration duration and the working duration is further based on optimizing an energy efficiency of the working period and the regeneration period.

In various embodiments, the method further includes: determining, based on optimizing the production rate of desired ions in the unidirectional pH adjustment cell in view of the parameters, a voltage to be applied by a power source during the working period. In various embodiments, charging the unidirectional pH adjustment cell for the determined working duration includes charging the unidirectional pH adjustment cell at the voltage for the determined working duration.

In various embodiments, the method further includes: determining, based on optimizing the production rate of desired ions in the unidirectional pH adjustment cell in view of the parameters, a flow rate of water to be supplied to the unidirectional pH adjustment cell; and adjusting the speed of a pump supplying water to the unidirectional pH adjustment cell based on the flow rate.

In various embodiments, charging the unidirectional pH adjustment cell for the determined working duration includes providing first voltage of a first polarity to the unidirectional pH adjustment cell and wherein discharging the unidirectional pH adjustment cell for the determined regeneration duration comprises providing second voltage of a second polarity to the unidirectional pH adjustment cell. In various embodiments, optimizing a production rate of desired ions in the unidirectional pH adjustment cell in view of the parameters includes applying at least one of: one or more objective formulas and one or more table values that are representative of optimized production rates.

In another aspect, a unidirectional pH adjustment apparatus may include: a unidirectional pH adjustment cell having an input for receiving water, a working electrode and a counter electrode that supply voltage to the water to unidirectionally adjust a pH value of the water, and an output for discharging the water with an adjusted pH value; a power supply supplying a first voltage of a first polarity to the working electrode during a working period of the working electrode; and a controller. The controller may be programmed to: obtain a plurality of parameters related to the unidirectional pH adjustment cell; determine, based on optimizing a production rate of desired ions in the unidirectional pH adjustment cell in view of the parameters, a working duration of the working period of the unidirectional pH adjustment cell and a regeneration duration of a regeneration period of the unidirectional pH adjustment cell; cause the power supply to supply the first voltage of the first polarity to the unidirectional pH adjustment cell for the determined working duration; and cause the power supply to not supply the first voltage of the first polarity to the unidirectional pH adjustment cell for the determined regeneration duration.

In various embodiments, the controller is programmed to cause the power supply to supply a second voltage of a second polarity to the unidirectional pH adjustment cell for the determined regeneration duration. In various embodiments, the apparatus may further include one or more sensors each providing one or more of the parameters to the controller.

In yet another aspect, a method of controlling regeneration of an electrode in unidirectional pH adjustment of water may include: obtaining a plurality of parameters related to a unidirectional pH adjustment cell, the unidirectional pH adjustment cell including a working electrode and a counter electrode; determining, based on optimizing an energy efficiency of the unidirectional pH adjustment cell in view of the parameters, a regeneration duration of a regeneration period of the unidirectional pH adjustment cell and a working duration of a working period of the unidirectional pH adjustment cell charging the unidirectional pH adjustment cell for the determined working duration and discharging the unidirectional pH adjustment cell for the determined regeneration duration.

In yet another aspect, a method of controlling regeneration of an electrode in unidirectional pH adjustment of water may include: obtaining a plurality of parameters related to a unidirectional pH adjustment cell, the unidirectional pH adjustment cell including a working electrode and a counter electrode; determining one or more optimized control parameters for the unidirectional pH adjustment cell based on optimizing at least one of: an energy efficiency of the unidirectional pH adjustment cell in view of the parameters, and a production rate of desired ions in the unidirectional pH adjustment cell; and controlling one or more inputs to the unidirectional pH adjustment cell based on the one or more optimized control parameters. In various embodiments, determining the one or more optimized control parameters for the unidirectional pH adjustment cell may include: determining the one or more optimized control parameters maximize an average production rate of desired ions during charging of the unidirectional pH adjustment cell; and determining the one or more optimized control parameters minimize a production rate of undesired ions during discharging of the unidirectional pH adjustment cell. In various embodiments, the one or more optimized control parameters comprises one or more of: a regeneration duration of a regeneration period; a voltage to be applied by a power source during the regeneration period; a working duration of a working period; a voltage to be applied by the power source during the working period; and a flow rate of water to be supplied to the unidirectional pH adjustment cell.

The term “controller” is used herein generally to describe various apparatus relating to the operation of one or more components associated with a UpA cell such as, for example, a power supply for the UpA cell, a pump or other apparatus controlling an amount of water that is supplied to the UpA cell, etc. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various embodiments, a processor or controller may be associated with one or more storage media (generically referred to herein as “memory”, e.g., volatile and non-volatile computer memory such as RAM, PROM, EPROM, and EEPROM, floppy disks, compact disks, optical disks, magnetic tape, etc.). In some embodiments, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the invention will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an example environment in which regeneration of an electrode in unidirectional pH adjustment of water may be controlled.

FIG. 2 illustrates an example of controlling a working period and a regeneration period of a UpA cell and/or controlling a flow rate of water supplied to the UpA cell.

FIG. 3 shows a rate of production of desired ions under different sets of working and regeneration durations for parameters.

FIG. 4 shows a rate of production of undesired ions under different sets of working and regeneration durations for parameters.

### DETAILED DESCRIPTION OF EMBODIMENTS

Unidirectional pH adjustment (“UpA”) is a technique for unidirectionally adjusting pH of water during water electrolysis only in one direction. In UpA there are two periods: a “working period” and a “regeneration period.” During the working period a working electrode is in a charging state while a counter electrode is generating ions required for the desired pH change. During the regeneration period, the working electrode is in a discharging state while the counter electrode is generating ions that are undesired for the desired pH change.

As described above, during the regeneration period the working electrode is discharging to enable the working electrode to again be charged during the charging state. The regeneration period may be set to occur upon occurrence of a fixed condition, such as when the working electrode is fully charged and/or when the transient voltage drop on the working electrode is close to the decomposing voltage of water. However, this and/or other techniques may suffer from one or more drawbacks. For example, one or more of the techniques may not determine discharging parameters with which the regeneration period is to be performed such as discharging time, a magnitude of reverse voltage applied during the regeneration period, etc. Also, for example, one or more of the techniques may not consider certain measured or otherwise known parameters related to a unidirectional pH adjustment cell to determine a charging status of a working electrode at which regeneration should be performed. Also, for example, one or more of the techniques may not take into account effects on the production rate of desired and/or undesired ions and/or energy efficiency in determining discharging parameters for a regeneration period and/or when the regeneration period should be performed.

Thus, applicant has recognized and appreciated that it would be beneficial to provide alternative techniques for controlling regeneration of an electrode in unidirectional pH adjustment of water. For example, applicant has recognized and appreciated that it would be beneficial to monitor one or more measured signals related to a UpA cell, and control when a regeneration period of the UpA cell is started, parameters for the regeneration period, and/or other parameters related to inputs to the UpA cell based on the values.

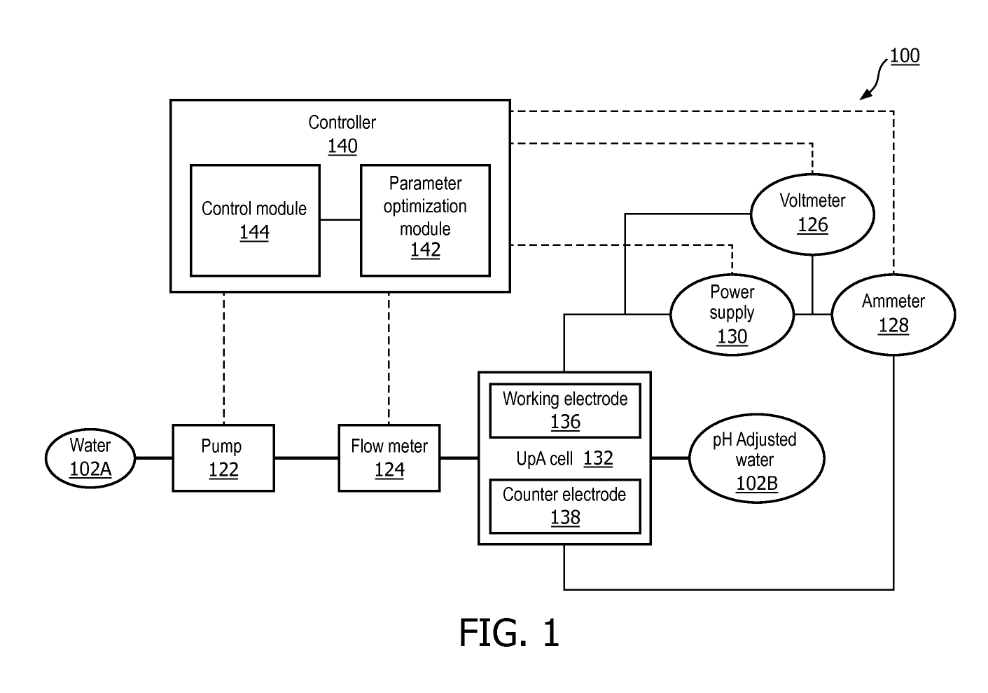

FIG. 1 illustrates an example environment 100 in which regeneration of an electrode in unidirectional pH adjustment of water may be controlled. The example environment 100 includes a pump 122 that supplies water 102A to a UpA cell 132 via one or more conduits. The water 102A may be supplied to the pump 122 via, for example, a municipal tap, a tank or other container, etc. The pump 122 may operate continuously or intermittently and may optionally be an adjustable pump that is operable over a range of speeds dependent on control signals received form the controller 140. In some embodiments, the output of the pump 122 may fluctuate over time due to mechanical wear on the pump 122 and/or other factors. For example, the output of the pump 122 may decrease over time due to mechanical wear of the pump 122.

Interposed between the pump 122 and the UpA cell 132 is a flow meter 124 that measures a quantity of water that is supplied by the pump 122 to the UpA cell 132 and generates signals that indicate the quantity of water. For example, the flow meter 124 may generate signals that indicate a number of gallons or liters per minute (or other flow rate) of water 102A that is supplied to the UpA cell 132. The UpA cell 132 includes a housing that houses water 102A received from the pump 122 and includes a working electrode 136 and a counter electrode 138 disposed in the housing. The working electrode 136 and counter electrode 138 work to unidirectionally adjust the pH of water 102A housed in the UpA cell. The pH adjusted water 102B is discharged by the UpA cell 132 to one or more downstream components such as residential or commercial components that discharge or otherwise utilize the pH adjusted water 102B. In some embodiments, a quantity of water 102A may be supplied by the pump 122 to the UpA cell 132, the pH value of that quantity of water may be adjusted by the pH cell 132, and that quantity of water discharged as pH adjusted water 102B, and the process may repeat. In some embodiments, water may be continuously supplied by the pump 122 to the UpA cell 132, adjusted by the UpA cell 132, and discharged as pH adjusted water 102B.

A power supply 130 is connected to the working electrode 136 of the UpA cell 132 and the counter electrode 138 of the UpA cell 132. The power supply 130 may be, for example, a DC power supply that is coupled to mains power and converts AC mains power into DC power of a desired magnitude of voltage. As described herein, the power supply 130 supplies DC power during working periods that is of an appropriate polarity to charge the working electrode 136. As also described herein, the power supply 130 may optionally supply DC power during the regenerations periods that is of an opposite polarity (from the working period polarity) to assist in discharging the working electrode 136.

The example environment 100 also includes a voltmeter 126 that is connected in parallel with the power supply 130 and is in series with the working electrode 136 and the counter electrode 138. The example environment also includes an ammeter 128 that is connected in series with the working electrode 136, the counter electrode 138, and the power supply 130. The voltmeter 126 measures the voltage of the circuit that includes the working electrode 136, the counter electrode 138, and the power supply 130. The ammeter 128 measures the current of that same circuit and may be, for example, a galvanometer.

The example environment 100 also includes a controller 140 that is coupled to the power supply 130 and controls when and/or how the power supply 130 supplies DC power to charge the working electrode 136, when and/or how the power supply 130 supplies DC power to discharge the working electrode 136, and/or when (if ever) the power supply 130 doesn't supply any DC power to the working electrode 136. For example, the controller 140 may control when the power supply 130 supplies DC power to charge the working electrode 136 during the working period (e.g., only after completion of a preceding regeneration period). Also, for example, the controller 140 may control a working duration of time that the power supply 130 supplies DC power to charge the working electrode 136 during a working period based on a determined optimized charging time. Also, for example, the controller 140 may control a voltage of the DC power supplied by the power supply 130 to charge the working electrode 136 during the working period based on a determined optimized charging voltage. Also, for example, the controller 140 may control a regeneration duration of time that the power supply 130 supplies DC power to discharge the working electrode 136 during a regeneration period based on a determined optimized discharging time. Also, for example, the controller 140 may control a voltage of the DC power supplied by the power supply 130 to discharge the working electrode 136 during the regeneration period based on a determined optimized discharging voltage

As described herein, during working periods, the working electrode 136 is in a charging state while the counter electrode 138 is generating ions required for the desired pH change. For example, where UpA is applied to decrease the pH of water, the counter electrode 138 produces required H+ ions during the working periods. On the other hand, where UpA is applied to increase the pH of water, the counter electrode 138 produces required OH− ions during the working periods. During the regeneration periods, the working electrode 136 is in a discharging state while the counter electrode 138 is generating ions that are undesired for the desired pH change. For example, where UpA is applied to decrease the pH of water, the counter electrode 138 produces undesired OH− ions during the regeneration periods. On the other hand, where UpA is applied to increase the pH of water, the counter electrode 138 produces undesired H+ ions during the regeneration periods.

The controller 140 includes a parameter optimization module 142 and a control module 144. Generally, the parameter optimization module 142 identifies a plurality of measured or otherwise known parameters indicative of states of various components related to the operation of the UpA cell 132 and determines one or more parameters related to inputs to the UpA cell based on the values. For example, the parameter optimization module 142 may obtain measured values from voltmeter 126, ammeter 128, and/or flow meter 124 and optionally additional parameters such as a time constant of the working electrode 136 and/or a capacitance of a capacitor of the working electrode 136. The additional parameters may be, for example, stored in memory associated with the controller 140 based on input during manufacture and/or input from a consumer via one or more user interface elements. The parameter optimization module 142 may utilize the measured or otherwise known parameters to determine optimized parameters for: a flow rate of water to the UpA cell 132, a regeneration duration for the UpA cell 132, a working duration for the UpA cell 132, a voltage to be provided during the regeneration period for the UpA cell 132, and/or a voltage to be provided during the working period for the UpA cell 132.

In some embodiments, the parameter optimization module 142 may determine the parameters related to inputs to the UpA cell 132 based on optimizing the total desired and/or undesired ions production rate and/or energy efficiency of the UpA cell 132 in view of the measured or otherwise known parameters. In some of those embodiments, the parameter optimization module 142 determines the parameters based on one or more formulae and/or table values that indicate those parameters will optimize (according to the formulae and/or table values) a production rate of desired ions in the UpA cell 132 and/or optimize (again, according to the formulae and/or table values) energy efficiency of the UpA cell 132, in view of the measured or otherwise known parameters. In some embodiments, optimizing a production rate and/or other value doesn't necessarily mean that it is absolutely the most optimal—rather that it is the most optimal in view of applied formulae and/or table values and in view of the measured or otherwise known parameters utilized in the applied formulae and/or table values.

As one example, assume the following parameters: an applied voltage supplied by power supply 130 during a working period (ε), an applied voltage supplied by power supply 130 during a working period (ε′), a charging time constant of the working electrode 136 (τ), a regenerating time constant of the working electrode 136 (τ′), a capacitance of the working electrode 136 (C), and a flow rate of water supplied to the UpA cell 132 (F). These values may be “known” based on, for example, signals received from voltmeter 126 and/or ammeter 128, the values being stored in non-volatile memory, and/or the values being inputted via one or more users via a user interface. Further assume V_{AC0} represents the voltage drop on the working electrode 136 at the time moment of starting charging (i.e., the start of the working period) of the working electrode 136 and V_{ACE} represents the voltage drop on the working electrode 136 at the time moment of starting discharging (i.e., the start of the regeneration period) of the working electrode 136. The parameter optimization module 142 may determine values for V_{AC0} and V_{ACE} that minimize the objective function: r₁=C*(V_{ACE}−V_{AC0})/(F*τ)/ln [(ε−V_{AC0})/(ε−V_{ACE})] and maximize the objective function: r₂=C*(V_{ACE}−V_{AC0})/(F*τ′)/ln [(ε′−V_{ACE})/(ε′−V_{AC0})]. The parameter optimization module 142 may further utilize the determined values for V_{AC0} and V_{ACE} to determine an optimized working duration and an optimized regeneration duration based on the following formulas:

working duration=τ*ln [(ε−V_{AC0})/(ε−V_{ACE})]

regeneration duration=τ′*ln [(V_{ACE}+ε′)/(V_{AC0}+ε′)]

Generally, the control module 144 utilizes one or more of the optimized parameters determined by the parameter optimization module 142 to control one or more inputs related to the UpA cell 132. For example, the control module 144 may control when and/or how power is provided by power supply 130 to effectuate determined optimized parameters. For instance, where the optimized parameters include a working duration and a regeneration duration, the control module 144 may direct the power supply 130 to supply a first voltage of a first polarity for the working duration and to supply a second voltage of a second polarity form the regeneration duration. Also, for example, where the optimized parameters include a voltage of the power supply 130 for the working period and/or a voltage of the power supply 130 for the regeneration period, the control module 144 may direct the power supply 130 to supply the respective voltages during the respective periods. Also, for example, where the optimized parameters include a flow rate of water during the working period and/or regeneration period, the control module 144 may adjust the speed of pump 122 to achieve such flow rate (optionally taking into account feedback from the flow meter 124).

One example of determining optimized parameters for inputs to the UpA cell 132 based on measure or otherwise known parameters is provided below with reference to formulas (1) through (9). Assume that the voltage drop on the working electrode 136 is V_{AC0} at the time moment of starting charging (i.e., the start of the working period) of the working electrode 136 and V_{ACE} at the time moment of starting discharging (i.e., the start of the regeneration period) of the working electrode 136, respectively. In other words, the charging of the working electrode 136 is stopped (i.e., the stop of the working period) and discharging is started (i.e., the start of the regeneration period) when the voltage drop on the working electrode 136 increases to V_{ACE}, and the discharging is stopped (i.e., the stop of the regeneration period) when the voltage drop on the working electrode 136 decreases to V_{AC0}. The control module 144 may start and/or stop the working period and regeneration period by sending appropriate signals to power supply 130 to, for example, cause power supply 130 to supply DC voltage of an appropriate polarity. In some embodiments, the control module 144 may determine when to start and/or stop working and regeneration periods based on previously determined working and regenerations durations. For example, the control module 144 may cause a working period to be performed, followed by a regeneration period, followed by another working period, another regeneration period, etc. In some embodiments, the control module 144 may utilize default settings for determining when to start and/or stop working and regeneration periods such as, for example, when the controller 140 is reset and/or first installed.

The transient voltage drop on working electrode 136 (Vw) during a working period can be expressed a function of: the applied voltage supplied by power supply 130 during the working period (ε), the duration of the working period/charging time (t_{W}), the charging time constant of the working electrode 136 (τ), and the voltage drop of the working electrode 136 at the start of the working period (V_{AC0}). The charging time constant (τ) of the working electrode 136 is the time required to charge the capacitor of working electrode 136, through the resistor of the working electrode 136, by approximately 63.2 percent of the difference between the initial value and final value.

The transient voltage drop on working electrode 136 (V_{w}) during a working period can be expressed mathematically as:

V_{W}=f(ε,τ,V_{AC0}) (1)

The generating rate of desired ions (r_{W}) (either H+ or OH−, depending on the embodiment) at time (t) during the working period is determined by the time t and a current I_{w}, which can be expressed mathematically as:

r_{W}=f(t,I_{W}) (2)

Current I_{W} can be expressed mathematically as:

I_{W}=C*(dV_{W}/dt), (3)

where C is the capacitance of the working electrode 136.

During the regeneration period, usually an inverse power supply is employed. For example, the polarity of the power supply 130 could be inverted (and optionally the voltage altered) and/or the power supply 130 may include a first power supply for use in the working period and a second power supply for use in the regeneration period. During the regeneration period, the transient voltage drop on the working electrode 136 (V_{R}) is the function of the total inverse voltage supplied during the regeneration period (ε′), the duration of the regeneration period/discharging time (t_{R}), the discharging time constant of the working electrode 136 (τ′), and the voltage drop of the working electrode 136 at the start of the regeneration period (V_{ACE}).

The transient voltage drop on working electrode 136 (V_{w}) during a regeneration period can be expressed mathematically as:

V_{R}=f(ε′,t,τ′,V_{ACE}) (4)

The generating rate of desired ions (r_{W}) (either H+ or OH⁻, depending on the embodiment) at time (t) during the regeneration period is determined by the time t and a current I_{R}, which can be expressed mathematically as:

r_{R}=f(t,I_{R}) (5)

Current I_{R} can be expressed mathematically as:

I_{R}=C*(dV_{R}/dt), (6)

where C is the capacitance of the working electrode 136.

In embodiments where the controller 140 determine states of one or more variables related to the control of the UpA cell 132 based on optimizing the total production rate and/or production efficiency of the UpA cell 132, the parameter optimization module 142 may seek to determine a working period duration and/or regeneration period duration that maximizes the total production of desired ions, minimizes the total production of undesired ions, and/or maximizes energy efficiency.

An average production rate of desired ions (r₁) over a working period (t_{W}) can be expressed mathematically as:

r₁=∫₀^{tW}rWdt/t_{W} (7)

An average production rate of undesired ions (r₂) over a regeneration period (t_{R}) can be expressed mathematically as:

r₂=∫₀^{R}rRdt/t_{R} (8)

Energy efficiency (E_{ff}) can expressed mathematically as:

E_{ff}=ΔH*rW/(I_{w}²*R+I_{R}²*R′), (9)

where:
ΔH=reaction heat needed for generating per molar desired ion, J/mol;
R=total electrical resistance of the circuit during working period, Ω;
R′=total electrical resistance of the circuit during regeneration period, Ω.

The parameter optimization module 142 may determine optimized parameters for a working and regeneration period based on formulas (7), (8), and/or (9) above. For example, the parameter optimization module 142 could determine a working duration of a working period and a regeneration duration of a regeneration period that maximize and minimize respective of the values of r₁ and r₂ and/or that maximize the value of E_{ff}. The control module 144 may utilize the determined optimized parameters to control the power supply 130 and/or other components.

Another example of determining optimized parameters for inputs to the UpA cell 132 based on measure or otherwise known parameters is provided below with reference to formulas (10) through (20).

The transient voltage drop on working electrode 136 (Vw) during a working period can be expressed mathematically as:

V_{W}=(ε−V_{AC0})*(1−exp(−t/τ))+V_{AC0} (10)

Current during the working period (I) can be expressed mathematically as:

I_{W}=C*(dV_{W}/dt) or I_{W}=C*(ε−V_{AC0})/τ*exp(−t/τ) (11)

The transient generating rate of desired ions (r_{W}) (either H+ or OH⁻, depending on the embodiment) at time (t) during the working period can be expressed mathematically as:

r_{W}=I_{W}/F, (12)

where F is the flow rate of water being supplied to the UpA cell (e.g., as indicated by flow meter 124).

The time needed for the voltage drop on the working electrode 136 to reach V_{ACE} can be calculated based on equation (10), and can be expressed mathematically as:

t_{W}=τ*ln [(ε−V_{AC0})/(ε−V_{ACE})] (13)

During a regeneration period, the total inverse voltage is c′, the initial voltage drop on the working electrode 136 is V_{ACE}, and the transient voltage drop on the working electrode 136 during the regeneration period is V_{R}. The relationship between these values can be expressed mathematically as:

(14)

$${V}_{R} + {ɛ}^{′} = {I}_{R} * {R}^{′} = {R}^{′} * C * ( \frac{{dV}_{R}}{dt} ) ,$$

where R′ is the resistance of the circuit during the regeneration period and C is the capacitance of the working electrode 136.

Integrating equation (14) produces:

V_{R}=(V_{ACE}+ε′)*exp(−t/τ′)−ε′ (15)

The time needed for the voltage drop on the working electrode 136 to decrease to V_{AC0} (t_{R}/the regeneration duration) during the regeneration period can be expressed mathematically as:

t_{R}=τ′ ln [(V_{ACE}+ε′)/(V_{AC0}+ε′)] (16)

Current (I_{R}) during the regeneration period can be expressed mathematically as:

I_{R}=−C*(dV_{R}/dt)=C*(ε′+V_{ACE})/τ′*exp(−t/τ′) (17)

The transient generating rate of undesired ions (rᵣ) (either H+ or OH⁻, depending on the embodiment) at time (t) during the regeneration period can be expressed mathematically as:

r_{R}=I_{R}/F, (18)

where F equals the flow rate of water into the UpA cell 132 (e.g., as measured by flow meter 124

From equations (7) and (8), the average production rate of desired ions (r₁) and undesired ions (r₂) during the working period and the regeneration periods can be expressed mathematically as:

r₁=C*(V_{ACE}−V_{AC0})/(F*τ)/ln [(ε−V_{AC0})/(ε−V_{ACE})] (19)

r₂=C*(V_{ACE}−V_{AC0})/(F*τ′)/ln [(ε′+V_{ACE})/(ε′+V_{AC0})] (20)

The parameter optimization module 142 may determine optimized parameters for a working and regeneration period based on formulas (19) and (20) above. For example, the parameter optimization module 142 could determine values of V_{AC0} and V_{ACE} that maximize and minimize respective of the values of r₁ and r₂. Meaningful ranges of V_{AC0} and V_{ACE} may be set to constrain the optimization process and/or for other considerations such as to account for known limits of the working electrode 136. The parameter optimization module 142 may further utilize the determined values for V_{AC0} and V_{ACE} to determine an optimized working duration and an optimized regeneration duration based on formulas (13) and (16). The control module 144 may utilize the determined optimized parameters to control the power supply 130 and/or other components.

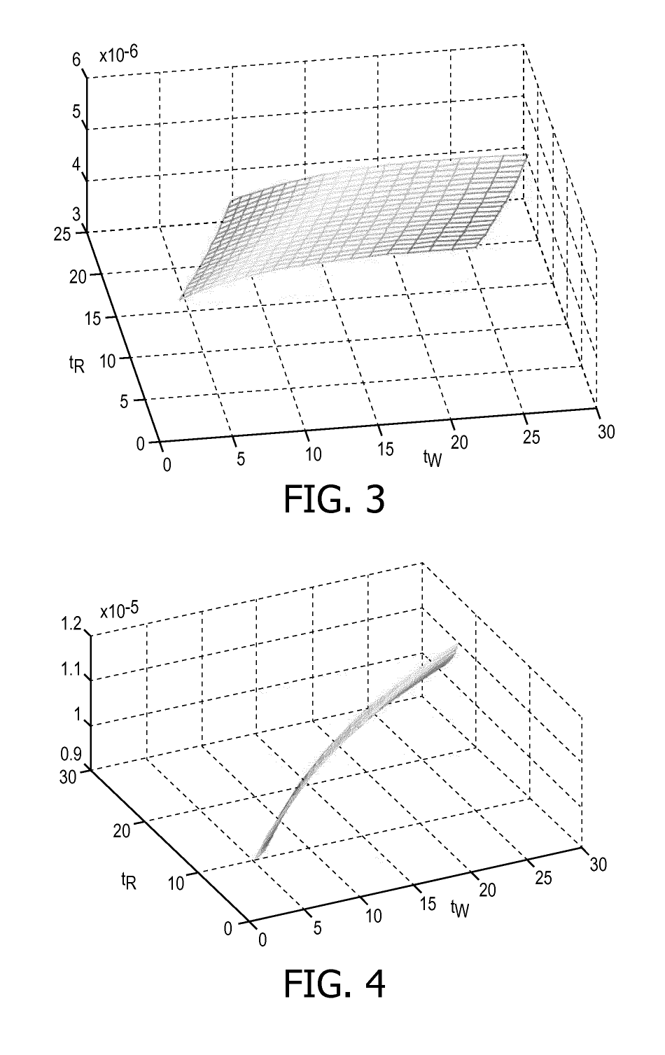

FIGS. 3 and 4 show the values of r₁ (FIG. 3) and r₂ (FIG. 4) under different sets of working and regeneration durations for parameters of ε=2 V, ε′=0.7 V, C=10 F, τ=30 s, and τ′=25 s. The assumed V_{ACE} range is 0.5-1.3 V and assumed V_{AC0} range is 0.1-0.4 V. The t_{W} axis in each of the figures represents the working period duration (in seconds) and the t_{R} axis in each of the figures represents the regeneration period duration (in seconds). The z-axis in each of the figures represents the rate of ion production (in mols per second). Based on formulas (19) and (20), the parameter optimization module 142 may determine that both the maximum value for r₁ and minimum value for r₂ are reached when the values of V_{AC0} and V_{ACE} are the smallest values in the corresponding meaningful ranges and the corresponding durations for working and regeneration periods are 7.1 s and 10.1 s, respectively. More parameters could be also optimized through the similar approach. For example, if the total inverse voltage (ε′) is changed from 0.7 V to 2.7 V, the corresponding optimized duration for regeneration becomes 3.3 s instead of 10.1 s.

In some embodiments of the example environment 100, one or more of the components may be included together as part of a UpA apparatus. For example, in some embodiments the UpA cell 132, the controller 140, the pump 122, the flow meter 124, the power supply 130, the voltmeter 126, and the ammeter 128 may be packaged in a common housing and/or multiple housing that are electrically and/or mechanically coupled to one another. The UpA apparatus may include connections to, for example, connect an input of the UpA apparatus to the water 102A and optionally to connect an output of the UpA apparatus (that outputs pH adjusted water 102B) to one or more downstream components. In some of those embodiments the connections may be pipe couplings.

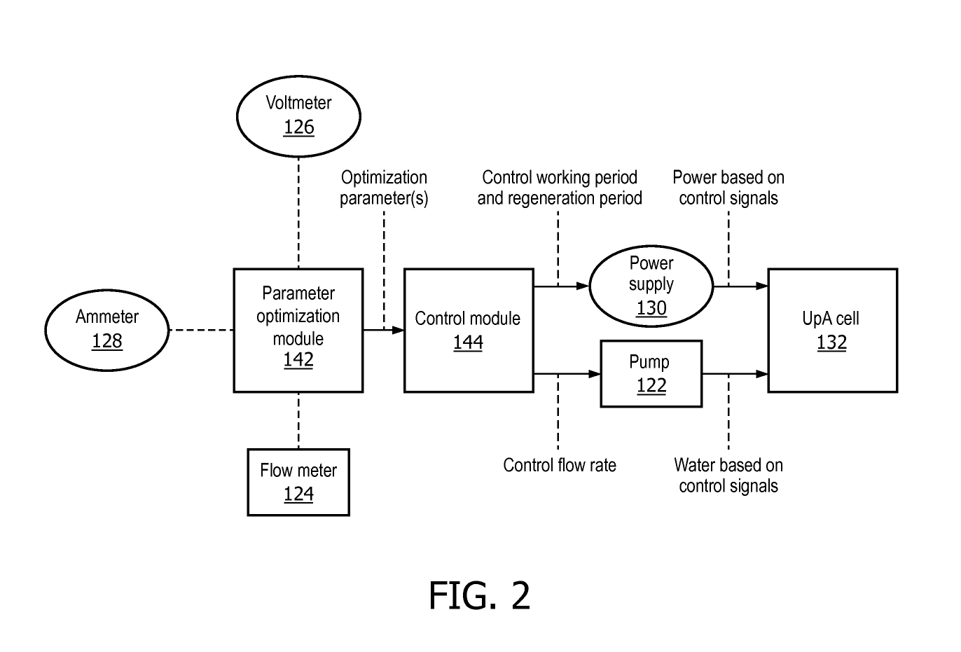

FIG. 2 illustrates an example of controlling a working period and a regeneration period of a UpA cell 132 and/or controlling a flow rate of water supplied to the UpA cell 132. The parameter optimization module 142 identifies a plurality of measured or otherwise known parameters indicative of states of various components related to the operation of the UpA cell 132. For example, one or more of the values may be measured values received by the parameter optimization module 142 from one or more of the flow meter 124, the voltmeter 126, and the ammeter 128. Also, for example, one or more of the values may be retrieved from non-volatile memory associated with the parameter optimization module 142 or programmed in the parameter optimization module 142, such as a time constant of the working electrode 136 and/or a capacitance of a capacitor of the working electrode 136.

The parameter optimization module 142 utilizes the measured or otherwise known parameters to determine optimized parameters related to inputs to the UpA cell such as, for example, one or more of: a flow rate of water to the UpA cell 132, a regeneration duration for the UpA cell 132, a working duration for the UpA cell 132, a voltage to be provided during the regeneration period for the UpA cell 132, and/or a voltage to be provided during the working period for the UpA cell 132. In some embodiments, the parameter optimization module 142 may determine the optimized parameters based on optimizing the total desired and/or undesired ions production rate and/or energy efficiency of the UpA cell 132 in view of the measured or otherwise known parameters. In some of those embodiments, the parameter optimization module 142 determines the parameters based on one or more formulae and/or table values that indicate those parameters will optimize a production rate of desired ions in the UpA cell 132 and/or optimize energy efficiency of the UpA cell 132, in view of the measured or otherwise known parameters.

The optimized parameters determined by the parameter optimization module 142 are provided to the control module 144. Generally, the control module 144 utilizes one or more of the optimized parameters to control one or more inputs related to the UpA cell 132. For example, as illustrated in FIG. 2, the control module 144 may control a working period and a regeneration period of the UpA cell based on the optimized parameters by providing signals to the power supply 130 that control when and/or how power is provided to the UpA cell 132 by power supply 130. The power supply 130 provides power to the UpA cell 132 based on the control signals received from the control module 144. For instance, where the optimized parameters include a working duration and a regeneration duration, the control module 144 may direct the power supply 130 to supply a first voltage of a first polarity for the working duration and to supply a second voltage of a second polarity form the regeneration duration. Also, for example, where the optimized parameters include a voltage of the power supply 130 for the working period and/or a voltage of the power supply 130 for the regeneration period, the control module 144 may direct the power supply 130 to supply the respective voltages during the respective periods.

As another example, where the optimized parameters include a flow rate of water during the working period and/or regeneration period, as illustrated in FIG. 2 the control module 144 may provide signals to the pump 122 to achieve that flow rate of water from the pump 122. The pump 122 provides water to the UpA cell 132 based on the control signals received from the control module 144. For instance, the parameter optimization module 142 may have determined an optimized parameter for a flow rate based on determining a value for “F” (within a meaningful range of F) in formulas (19) and (20) above that maximize and minimize respective of the values of r₁ and r₂ (while optionally maximizing/minimizing those values in view of other values that can be adjusted such as V_{ACE}, V_{AC0}, ε, ε′). The control module 144 may utilize the value of F to control the pump 122.

An example of method of controlling one or more inputs to a UpA cell based on control parameters determined based on optimizing a production rate of desired ions and/or energy efficiency can be described as follows.

In a first step, a plurality of parameters related to an UpA cell are identified. For example, the parameter optimization module 142 may receive one or more measured values from one or more of the flow meter 124, the voltmeter 126, and the ammeter 128. Also, for example, one or more of the values may be retrieved from non-volatile memory associated with the parameter optimization module 142, programmed in the parameter optimization module 142, and/or received from user input at a user interface element.

In a second step, one or more control parameters for the UpA cell are determined based on optimizing a production rate of desired ions and/or energy efficiency in view of the parameters. For example, the parameter optimization module 142 may determine the optimized parameters based on optimizing the total desired and/or undesired ions production rate and/or energy efficiency of the UpA cell 132 in view of the measured or otherwise known parameters. In some of those embodiments, the parameter optimization module 142 determines the parameters based on one or more formulae and/or table values that indicate those parameters will optimize a production rate of desired ions in the UpA cell 132 and/or optimize energy efficiency of the UpA cell 132, in view of the measured or otherwise known parameters. For instance, the parameter optimization module 142 may utilize one or more of formulas (7), (8), (9), (19), and (20).

In a third step, one or more inputs to the UpA cell are controlled based on the determined control parameters. For example, the control module 144 may utilize one or more of the optimized parameters to control one or more inputs related to the UpA cell 132. For instance, the control module 144 may control a working period and a regeneration period of the UpA cell 132 based on the optimized parameters by providing signals to the power supply 130 that control when and/or how power is provided to the UpA cell 132 by power supply 130. Also, for instance, where the optimized parameters include a flow rate of water during the working period and/or regeneration period, the control module 144 may provide signals to the pump 122 to achieve that flow rate of water from the pump 122.

The one or more inputs to the UpA cell may continue to be controlled. In some embodiments, the first and second steps may be repeated to determine new control parameters and the one or more inputs to the UpA cell controlled based on the new control parameters. For example, the controller 140 may periodically or continuously perform all 3 steps. Also, for example, the controller 140 may perform the first and second steps upon detection of a change in one or more measured values such as changes indicated by received signals from flow meter 124, voltmeter 126, and/or ammeter 128.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and/or by means of a suitably programmed processor. In the device claim enumerating several means, several of these means may be embodied by one and the same item of hardware. The mere fact that certain measures are recited in mutually different dependent claims does not indicate that a combination of these measures cannot be used to advantage.

1. A method of controlling regeneration of an electrode in unidirectional pH adjustment of water, the method comprising:
obtaining a plurality of parameters related to a unidirectional pH adjustment cell (132), the unidirectional pH adjustment cell including a working electrode and a counter electrode;
determining a regeneration duration of a regeneration period of the unidirectional pH adjustment cell and a working duration of a working period of the unidirectional pH adjustment cell (305) in dependence on the parameters;
charging the unidirectional pH adjustment cell for the determined working duration; and
discharging the unidirectional pH adjustment cell for the determined regeneration duration.

2. The method of claim 1, wherein the plurality of parameters includes a value from a sensor sensing the parameter.

3. The method of claim 2, wherein the sensor is a flow meter and the value is a flow rate of water provided to the unidirectional pH adjustment cell.

4. The method of claim 2, wherein the sensor is a voltmeter and the value is a voltage of a circuit that includes the working electrode, the counter electrode, and a power supply coupled to the working electrode and the counter electrode.

5. The method of any of the preceding claims, wherein determining the regeneration duration and the working duration comprises:
determining the regeneration duration to maximize an average production rate of desired ions during charging of the unidirectional pH adjustment cell; and
determining the regeneration duration to minimize a production rate of undesired ions during discharging of the unidirectional pH adjustment cell.

6. The method of claim 5, wherein determining the regeneration duration and the working duration comprises:
determining a working voltage drop of the working electrode at a start of the working period (V_{AC0}) and a regeneration voltage drop of the working electrode at a start of the regeneration period (V_{ACE}) that minimize a first objective function in view of the parameters and that maximize a second objective function in view of the parameters, the first objective function being indicative of an average production rate of desired ions during charging of the unidirectional pH adjustment cell, and the second objective function being indicative of an average production rate of undesired ions during discharging of the unidirectional pH adjustment cell; and
determining the regeneration duration and the working duration based on the determined working voltage drop of the working electrode at a start of the working period (V_{A}co) and regeneration voltage drop of the working electrode at a start of the regeneration period (V_{ACE}).

7. The method of any of the preceding claims, further comprising:
determining, based on optimizing the production rate of desired ions in the unidirectional pH adjustment cell in view of the parameters, a voltage to be applied by a power source during the working period; and
wherein charging the unidirectional pH adjustment cell for the determined working duration comprises charging the unidirectional pH adjustment cell at the voltage for the determined working duration.

8. The method of any of the preceding claims, further comprising:
determining, based on optimizing the production rate of desired ions in the unidirectional pH adjustment cell in view of the parameters, a flow rate of water to be supplied to the unidirectional pH adjustment cell; and
adjusting the speed of a pump supplying water to the unidirectional pH adjustment cell based on the flow rate.

9. The method of any of the preceding claims, wherein charging the unidirectional pH adjustment cell for the determined working duration comprises providing first voltage of a first polarity to the unidirectional pH adjustment cell and wherein discharging the unidirectional pH adjustment cell for the determined regeneration duration comprises providing second voltage of a second polarity to the unidirectional pH adjustment cell.

10. The method of any of the preceding claims, wherein determining the regeneration duration and the working duration comprises applying at least one of: one or more objective formulas and one or more table values that are representative of optimized production rates.

11. A unidirectional pH adjustment apparatus, comprising:
a unidirectional pH adjustment cell (132) having an input for receiving water, a working electrode (136) and a counter electrode (138) that supply voltage to the water to unidirectionally adjust a pH value of the water, and an output for discharging the water with an adjusted pH value;
a power supply (130) supplying a first voltage of a first polarity to the working electrode (136) during a working period of the working electrode (136);
a controller (140) arranged to:
obtain a plurality of parameters related to the unidirectional pH adjustment cell;
determine a working duration of the working period of the unidirectional pH adjustment cell and a regeneration duration of a regeneration period of the unidirectional pH adjustment cell in dependence on the parameters;
cause the power supply (130) to supply the first voltage of the first polarity to the unidirectional pH adjustment cell for the determined working duration; and
cause the power supply (130) to not supply the first voltage of the first polarity to the unidirectional pH adjustment cell for the determined regeneration duration.

12. The unidirectional pH adjustment apparatus of claim 11, wherein the controller is arranged to cause the power supply (130) to supply a second voltage of a second polarity to the unidirectional pH adjustment cell for the determined regeneration duration.

13. The unidirectional pH adjustment apparatus of claim 11 or 12, further comprising one or more sensors (124, 126, 128) each providing one or more of the parameters to the controller.

14. The unidirectional pH adjustment apparatus of any of the preceding claims 11-13, wherein the controller is arranged to:
determine the regeneration duration to maximize an average production rate of desired ions during charging of the unidirectional pH adjustment cell; and
determine the regeneration duration to minimize a production rate of undesired ions during discharging of the unidirectional pH adjustment cell.

15. The unidirectional pH adjustment apparatus of any of the preceding claims 11-14, wherein the controller is arranged to:
determine a working voltage drop of the working electrode at a start of the working period (V_{AC0}) and a regeneration voltage drop of the working electrode at a start of the regeneration period (V_{ACE}) that minimize a first objective function in view of the parameters and that maximize a second objective function in view of the parameters, the first objective function indicative of an average production rate of desired ions during charging of the unidirectional pH adjustment cell, and the second objective function indicative of an average production rate of undesired ions during discharging of the unidirectional pH adjustment cell; and
determine the regeneration duration and the working duration based on the determined working voltage drop of the working electrode at a start of the working period (V_{AC0}) and regeneration voltage drop of the working electrode at a start of the regeneration period (V_{ACE}).
